(19) United States
(12) Patent Application Publication
(10) Pub. No.: US 2004/0158517 A1
(43) Pub. Date: Aug. 12, 2004

(54) Method for maximizing retirement income using financial bridge products and deferred social security income

(76) Inventors: James I. Mahaney, Upper Montclair, NJ (US); Peter C. Carlson, Edison, NJ (US)

Correspondence Address: Wolff & Samson PC, One Boland Drive, West Orange, NJ, 07052, US

(21) Appl. No.: 10/774,058

(22) Filed: Feb. 6, 2004

(51) Int. Cl. G06F 17/60

(52) U.S. Cl. 705/36

(57) ABSTRACT

The present invention provides a method for maximizing retirement income using bridge annuities and deferred Social Security income. Financial information about a client is gathered, in addition to financial information about the client's spouse, if applicable. A variety of income scenarios are modeled using the financial information and a plurality of income models, each model including income from a bridge product and deferred Social Security income. Alternate funding approaches are projected using the financial information, and the modeled scenarios are compared to the alternate funding approaches to determine the optimal scenario for maximizing retirement income. The client can then purchase a bridge product in accordance with the optimal scenario.

### BACKGROUND OF THE INVENTION

1. Field of the Invention

The present invention relates to a method for maximizing retirement income using financial bridge products and deferred Social Security income.

2. Related Art

In recent years, employees have become increasingly responsible for providing retirement income. In large part, such responsibility is attributable to a shift by employers away from defined benefit pension plans to defined contribution plans, such as 401(k) plans. Additionally, Social Security income is relied upon to supplement retirement income. However, income provided to a retired person by these sources may not be sufficient because of inflation, increases in cost of living expenses, spending of savings, longevity, investment performance, investment expenses, taxation, and other factors. Thus, there is a need to maximize retirement income over the course of one's retirement.

Regulations of the Social Security Administration provide that an individual can withdraw Social Security benefits at a pre-defined full retirement age. Prior to the full retirement age, reduced benefits can be taken as early as age 62. However, delayed retirement credits are awarded by the Social Security Administration if Social Security benefits are deferred past the full retirement age. Accordingly, there is an incentive for individuals to defer Social Security income as long as possible. However, if such income is deferred, the individual must be provided with an alternate source of retirement income (i.e., a bridge product) extending from the actual date of retirement to the deferred date of receipt of Social Security benefits.

There are numerous financial products used by individuals to save money and/or to provide income. For example, an annuity represents a financial product, often in the form of a contract between a prospective retiree and an insurance company, whereby payments are provided to the retiree at specified intervals after retirement. Annuities are tax-deferred, whereby annuity income is not taxed until withdrawal. A fixed annuity provides a constant payment amount over the life of the annuity, while a variable annuity does not. Other financial products include, but are not limited to, Funding Agreement Note Issuance Program (FANIP), settlement option under a deferred annuity, automatic withdrawals from deferred annuities or mutual funds, certificates of deposit, bonds, and fixed income.

While deferred Social Security benefits and annuities are known in the art, what presently is lacking is an efficient method for maximizing retirement income, wherein a variety of income scenarios of a potential retiree and his/her spouse are modeled, the client can select an optimal scenario, and the client is provided with at least one financial bridge product and defers Social Security benefits to maximize retirement income.

### SUMMARY OF THE INVENTION

The present invention relates to a method for maximizing retirement income using deferred Social Security income and a financial bridge product, such as a bridge annuity, Funding Agreement Note Issuance Program (FANIP), settlement option under a deferred annuity, automatic withdrawals from deferred annuities or mutual funds, certificates of deposit, bonds, fixed income, or other suitable financial bridge product. Financial information about a client is gathered, in addition to financial information about the client's spouse, if applicable. Future income scenarios are modeled using a plurality of income models, each of the models including a bridge product and deferred Social Security income. The modeled scenarios can be adjusted according to the client's desires and/or needs. Income from the bridge product can be wrapped around Social Security payments to provide desired income levels during retirement. Alternate funding approaches including traditional 401(k) plans and IRA accounts are projected using the financial information. The modeled scenarios are compared to the alternate funding approaches to determine the optimal scenario for maximizing retirement income. The client can then purchase a bridge product in accordance with the optimal scenario.

According to the first income model of the present invention, a determination is made as to whether the client is a single individual or a married couple. If the client is single, the client is provided with a bridge product covering the time period spanning between the individual's date of retirement and date of receipt of delayed Social Security benefits. When the individual retires, income is provided from the bridge product and Social Security benefits are delayed until a delayed Social Security receipt date. At the delayed receipt date, income from the bridge product is exhausted and deferred Social Security benefits are taken until the client's death. If the client is a married couple, the couple is provided with a bridge product covering the time period spanning between the primary Social Security recipient's earliest retirement date and the date of receipt of delayed Social Security benefits. When the primary individual retires, income for the couple is provided from the bridge product and Social Security benefits are delayed until the delayed Social Security receipt date. At the delayed receipt date, income from the bridge product is exhausted and deferred Social Security benefits are taken. In addition to income from the bridge product, the individual's spouse receives his or her own Social Security benefits at the spouse's earliest retirement date. Additionally, the spouse receives spousal Social Security benefits if the spouse is entitled to such benefits and when the primary individual reaches the full retirement age defined by the Social Security Administration.

According to the second income model of the present invention, a married couple is provided with a bridge product covering the time period spanning between the primary individual's date of retirement and date of receipt of delayed Social Security benefits. When the primary individual retires, income for the couple is provided from the bridge product and Social Security benefits are delayed until a pre-determined receipt date. At the delayed receipt date, income from the bridge product is exhausted and deferred Social Security benefits are taken. The individual's spouse receives his or her own Social Security benefits at an earliest retirement date, but does not receive spousal Social Security benefits until both the spouse and the primary individual reach the full retirement age.

According to the third income model of the present invention, a married couple is provided with a bridge product covering the time period spanning between the primary individual's date of retirement and date of receipt of delayed Social Security benefits. When the primary individual retires, income for the couple is provided from the bridge product and Social Security benefits are delayed until a pre-determined receipt date. At the pre-determined receipt date, income from the bridge product is exhausted and deferred Social Security benefits are taken. The individual's spouse receives his or her own Social Security benefits, in addition to spousal Social Security benefits, at the full retirement age.

According to the fourth income model of the present invention, a husband and a wife of a married couple are provided with respective bridge products covering the time period spanning between each individual's date of retirement and date of receipt of delayed Social Security benefits. When each individual retires, income for the couple is provided from the bridge products and Social Security benefits are delayed until a pre-determined receipt date. At the predetermined receipt date, income from the bridge products is exhausted and deferred Social Security benefits are taken.

### BRIEF DESCRIPTION OF THE DRAWINGS

Other important objects and features of the invention will be apparent from the following Detailed Description of the Invention taken in connection with the accompanying drawings in which:

FIG. 1 is a flowchart showing the method of the present invention for maximizing retirement income.

FIG. 2 is a flowchart showing bridge product length and cost calculation step of FIG. 1 in greater detail.

FIG. 3a is a flowchart showing the first income model according to the present invention; FIGS. 3b-3c are graphs showing projected retirement incomes using the model shown in FIG. 3a.

FIG. 4a is a flowchart showing a second income model according to the present invention; FIG. 4b is a graph showing projected retirement income using the model shown in FIG. 4a.

FIG. 5a is a flowchart showing a third income model according to the present invention; FIGS. 5b-5c are graphs showing projected retirement income using the model shown in FIG. 5a.

FIG. 6a is a flowchart showing a fourth income model according to the present invention; FIGS. 6b-6c are graphs showing projected retirement income using the model shown in FIG. 6a.

FIGS. 7 and 8 are flowcharts showing the alternate funding calculation step of FIG. 1 in greater detail.

FIGS. 9 and 10 are flowcharts showing the alternate funding comparison step of FIG. 1 in greater detail.

### DETAILED DESCRIPTION OF THE INVENTION

The present invention relates to a method for maximizing retirement income using bridge products and deferred Social Security income. By deferring Social Security income to a later date in retirement, e.g., to an age later than the full retirement age (“FRA”) defined by the Social Security administration, or other age, Social Security income can be maximized. According to the method of the present invention, financial information about a client is gathered, in addition to financial information about the client's spouse, if applicable. A variety of income scenarios are modeled using the financial information and a plurality of income models, each model including a bridge product and deferred Social Security income. Alternate funding approaches are projected using the financial information, and the modeled scenarios are compared to the alternate funding approaches to determine the optimal scenario for maximizing retirement income. The client can then purchase one or more bridge products in accordance with the optimal scenario.

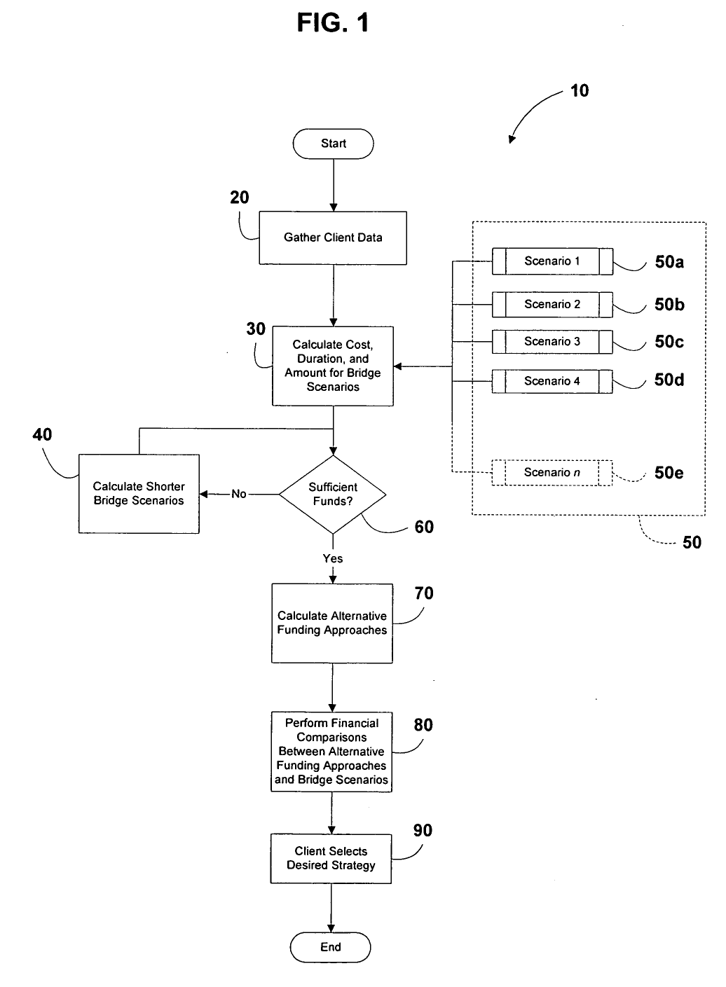

FIG. 1 is a flowchart showing the method of the present invention, indicated generally at 10, for maximizing retirement income. The method 10 can be practiced by an insurance agent, actuary, accountant, financial planner, or any individual rendering financial services for a client, or even by the client. Further, the method 10 could be programmed as a financial planning application and executed by one or more computer systems. Beginning in step 20, information about the client is gathered. The client could be a single individual or a married couple. Information gathered in step 20 includes, but is not limited to, one or more of the following: name, date of birth, qualified retirement account balance, target yearly income, annual inflation rate assumption, annuity start date, modeling age, expected amount of taxable fixed income, expected amount of monthly taxable, inflation-protected income, expected amount of monthly non-taxable, fixed income, expected amount of monthly non-taxable, inflation-protected income, inflation-adjusted assumption used to calculate other income, amount of other temporary income, length of time expected to receive temporary income, growth percentage of other income, federal tax status, rate of return assumptions for invested retirement funds, expected expenses of retirement funds (including financial advisor and other applicable fees), accumulated monthly Social Security benefit in today's dollars (or future dollars), and exact age until which benefits can be collected. The information collected in step 20 can be gathered verbally, in writing (i.e., by filling out a questionnaire), or by one or more user interface screens on a computer system.

In step 30, one or more bridge product amounts, durations, and costs are calculated using the information collected in step 20, in one or more scenarios 50. By the term “bridge product” it is meant any financial product capable of providing periodic (e.g., monthly) income payments, such as an annuity, Funding Agreement Note Issuance Program (FANIP), settlement option under a deferred annuity, automatic withdrawals from deferred annuities or mutual funds, certificates of deposit, bonds, fixed income, retail notes (e.g., medium term notes) or other suitable product. The scenarios 50, which comprise individual scenarios 50a-50d and, optionally, additional scenarios 50e, are modeled in accordance with income models that are unique to the present invention. One or more of the scenarios 50 can be selected by the client for modeling and future income projection.

In step 60, a determination is made as to whether the client presently has sufficient funds to purchase at least one bridge product modeled in at least one of the scenarios 50. If a negative determination is made, step 40 occurs, wherein a shorter bridge product is calculated for the one or more scenarios 50, until the client can afford to purchase the bridge product. If a positive determination is made, step 70 is invoked, wherein alternate funding approaches are calculated. Examples of alternate funding approaches include, but are not limited to, Individual Retirement Accounts (IRAs), 401(k) plans, savings accounts, and traditional Social Security benefits. Then, in step 80, financial comparisons are performed between the alternate funding approaches and the one or more modeled scenarios 50. This allows the client to compare, numerically and/or graphically, the results of selecting one or more of the scenarios 50 versus one or more of the alternate funding approaches. In step 90, based upon the comparisons performed in step 80, the client selects a desired financial strategy. In most cases, the client will select one of the modeled scenarios 50, due to the financial benefits of purchasing a bridge product and deferring Social Security income. When one of the scenarios is selected in step 90, the client then purchases a bridge product, from an insurance agent, financial entity or other applicable entity, that has been modeled in one of the scenarios 50 and has the parameters (i.e., duration, total purchase amount, and payout amounts) calculated in step 30.

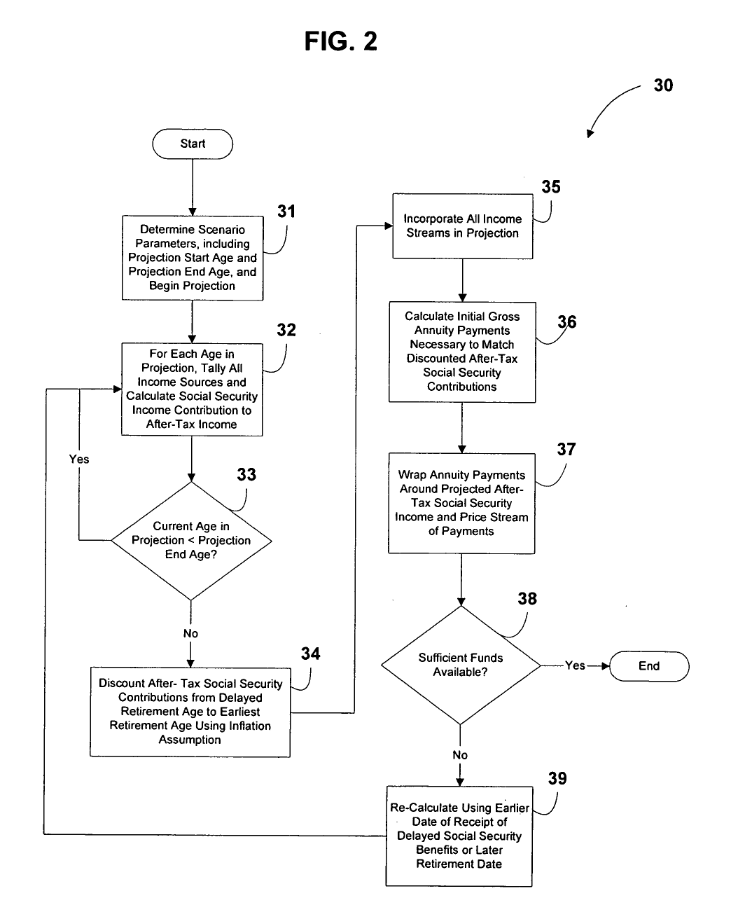

FIG. 2 is a flowchart showing the bridge product length and cost calculation step 30 of FIG. 1 in greater detail. The process 30 allows for the calculation and adjustment of costs, duration, and payout amounts for one or more of the bridge scenarios 50 shown in FIG. 1. Beginning in step 31, scenario parameters, including primary and spousal social security filing and suspension dates, bridge product payout dates, retirement ages, and delayed social security receipt dates, are determined. Additionally, a starting age and an ending age for payout projections are determined, and income payment projections begin. In step 32, for each age in the projection, all income sources, including, but not limited to, Social Security payments, other income sources, and bridge product payments, are tallied, and Social Security income contributions to after-tax income are calculated. Optionally, pre-tax income contributions could also be calculated in step 32. In step 33, a determination is made as to whether the current projection age is less than the ending projection age. If a positive determination is made, step 32 is repeated, and the next age in the projection is calculated. If a negative determination is made (i.e., the projection end age is reached), step 34 is invoked, wherein after-tax Social Security contributions are discounted from a delayed retirement age (e.g., age 70) to an earliest retirement age (e.g., age 62), using an inflation assumption. Further, pre-tax Social Security contributions could be discounted in step 34 from the delayed retirement age to the earliest retirement age, using an inflation assumption.

In step 35, all income streams are incorporated into the projection, including temporary income and any other applicable income source. Then, in step 36, initial gross annuity payments necessary to match the discounted after-tax social security contributions are calculated. Optionally, payments for any other bridge product in addition to an annuity could be calculated in step 36. Then, in step 37 bridge product (e.g., annuity) payments are wrapped around the projected after-tax Social Security income payments, and a stream of payments are priced. In step 38, a determination is made as to whether the client has sufficient funds to purchase the bridge product (e.g., annuity). If a positive determination is made, process 30 ends. Otherwise, step 39 is invoked, wherein the bridge scenario is re-calculated using an earlier date of receipt of delayed Social Security benefits (e.g., less than age 70), or a later retirement date (e.g., greater than age 62). Step 32 is then repeated, so that the bridge scenario can be re-calculated in accordance with process 30. The projections calculated in step 30 can start at any desired date, and can extend to any desired termination date, such as age 95.

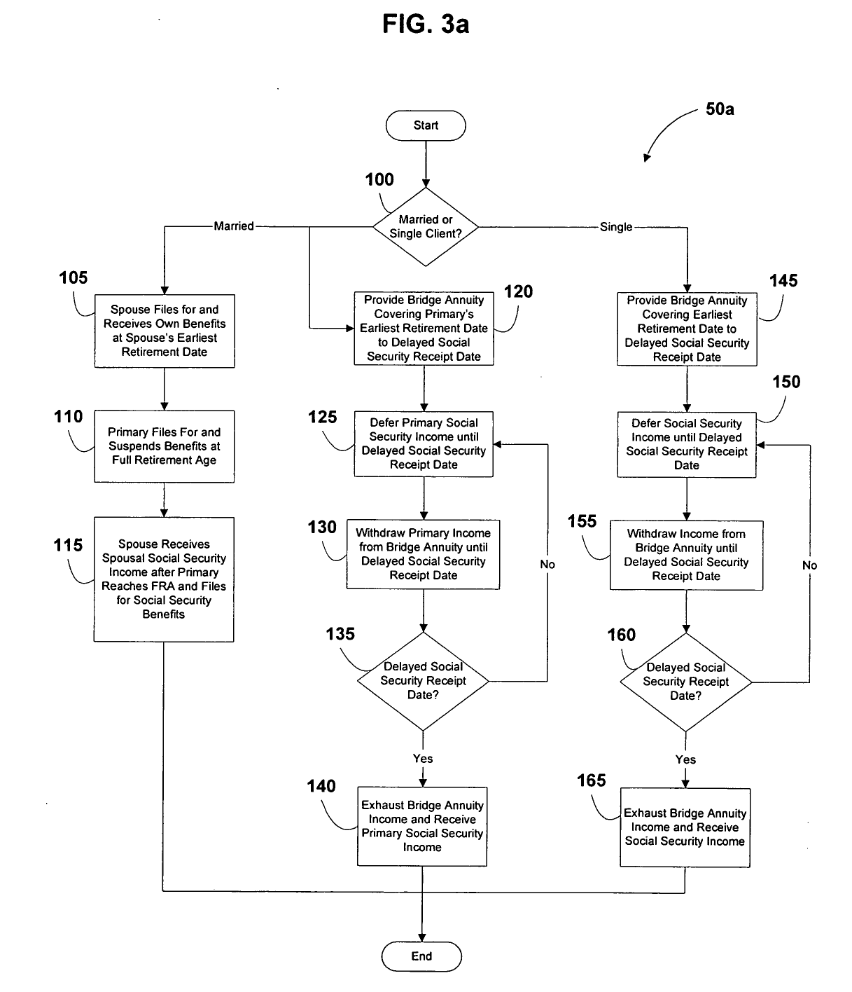

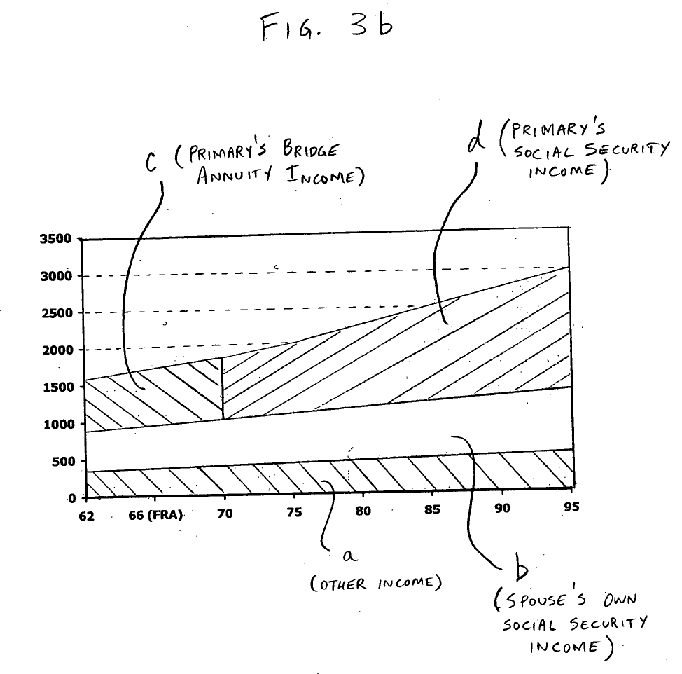

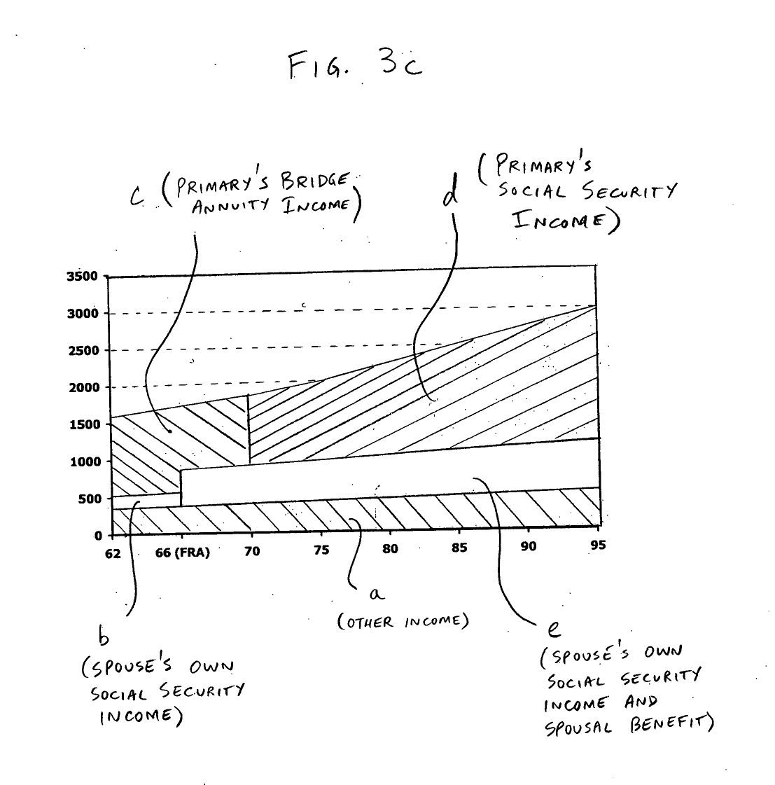

As mentioned earlier, each of the scenarios 50 of FIG. 1 are modeled in accordance with income models that are unique to the present invention. Those models will now be described with reference to FIGS. 3a-6d. As used herein, the terms “model” and “scenario” are used interchangeably. Further, the models shown in FIGS. 3a-6d and described herein disclose the use of a bridge annuity and deferred Social Security income to maximize retirement income. However, it is to be expressly understood that any suitable financial bridge product, such as a Funding Agreement Note Issuance Program (FANIP), settlement option under a deferred annuity, automatic withdrawals from deferred annuities or mutual funds, certificates of deposit, bonds, fixed income, retail notes, or other suitable bridge product, can be utilized in place of a bridge annuity, or in conjunction therewith, without departing from the spirit or scope of the present invention. Additionally, each of the models described herein can model other income sources (e.g., source of income other than bridge product income and Social Security income, such as temporary retirement income from a part-time job, or other similar source), and bridge product and deferred Social Security payments can be calculated while taking into consideration such other income. Further, income can be provided from more than one bridge product, e.g., income could be provided from more than one bridge annuity. Importantly, each of the models disclosed herein allow for bridge payments to be custom-tailored to each client, whereby payments can be “wrapped” around existing income sources to provide a consistent, inflation-protected stream of income for a client.

FIG. 3a is a flowchart showing the first income model (or, scenario) according to the present invention, indicated generally at 50a. The model 50a projects future income for a single or married client. For a married client, the spouse takes all Social Security benefits as soon as possible. Beginning in step 100, a determination is made as to whether the client is single or married. If the client is married, step 105 occurs, wherein the spouse files for and receives his or her own Social Security benefits at the spouse's earliest retirement date at which Social Security benefits are available. Presently, the earliest entitlement age for Social Security benefits is age 62, but this age can fluctuate according to changes in regulations of the Social Security Administration. Further, the spouse's earliest retirement date could be later than the earliest entitlement date for Social Security benefits, e.g., age 63 or older. In step 110, the primary recipient files for and suspends receiving Social Security benefits at a Full Retirement Age (“FRA”). The FRA is set forth by the regulations of the Social Security Administration, and is anticipated to increase to age 67 in the future.

Depending upon the income level of the spouse, the spouse may also be entitled to a Social Security spousal benefit if the spouse's Social Security primary insurance amount is less than one half of the primary beneficiary's primary insurance amount. Such benefits, if available, can only be received after the primary beneficiary has filed for benefits. If this is the case, in step 115, the spouse receives spousal Social Security income after the primary recipient is eligible and files for benefits. The spouse can then receive spousal Social Security benefits as early as age 62, or at any later point.

In addition to steps 105-115, if the client is married, steps 120-140 are also carried out. In step 120, a bridge annuity is established covering the time period extending between the primary recipient's earliest date of retirement to a pre-determined date for receiving delayed Social Security income benefits. Preferably, the delayed Social Security receipt date is age 70, but other ages could be utilized and modeled. In step 125, the primary beneficiary's Social Security income is deferred until the primary beneficiary reaches the deferred Social Security receipt date. Then, in step 130, income is withdrawn from the bridge annuity until the deferred Social Security receipt date. In step 135, a determination is made as to whether the primary beneficiary has reached the age for receiving deferred Social Security benefits (e.g., age 70). If a negative determination is made, steps 125 and 130 are repeated, so that income is continued to be withdrawn from the bridge annuity and Social Security benefits are deferred. If a positive determination is made in step 135, i.e., the primary beneficiary has reached the age for receiving deferred Social Security benefits (e.g., age 70), then step 140 occurs. In step 140, income from the bridge annuity is exhausted, and the primary beneficiary begins receiving deferred Social Security income.

In the event that a determination is made in step 100 that the client is single, step 145 is invoked. In step 145, a bridge annuity is established covering the time period extending between the earliest retirement date of the client to a pre-determined date for receiving delayed Social Security income benefits. Preferably, the delayed Social Security receipt date is age 70, but other ages could be utilized and modeled. In step 150, the client's Social Security income is deferred until the client reaches the deferred Social Security receipt date. Then, in step 155, income is withdrawn from the bridge annuity until the deferred Social Security receipt date. In step 160, a determination is made as to whether the client has reached the age for receiving deferred Social Security benefits (e.g., age 70). If a negative determination is made, steps 150 and 155 are repeated, so that income is continued to be withdrawn from the bridge annuity and Social Security benefits are deferred. If a positive determination is made in step 160, i.e., the client has reached the age for receiving deferred Social Security benefits (e.g., age 70), then step 165 occurs. In step 165, income from the bridge annuity is exhausted, and the primary beneficiary begins receiving deferred Social Security income.

FIG. 3b is a graph showing projected retirement income using the model shown in FIG. 3a. This graph shows projected income streams for a married couple, wherein the spouse's own Social Security benefits are taken as early as possible and the Social Security spousal benefit is unavailable (i.e., the spouse's own Social Security income is greater than one half of the income of the primary recipient). Other income sources are shown in area A of the graph. Area B represents the spouse's own Social Security income. Income from the bridge annuity is shown in area C, and for purposes of illustration only, occurs from ages 62 to 70. Of course, the bridge annuity could provide income at ages earlier than age 62, e.g., at ages 61 or earlier. Moreover, Social Security income could be deferred by the primary beneficiary until an age earlier than age 70, and income from the bridge annuity could extend to such age. The primary beneficiary's Social Security income is shown in area D of the graph, beginning at age 70.

FIG. 3c is a graph showing projected retirement income using the model shown in FIG. 3a. This graph shows projected income streams for a married couple, wherein the spouse's own Social Security benefits are taken as early as possible and the Social Security spousal benefit is available (i.e., the spouse's own Social Security income is less than one half of the income of the primary recipient). In this case, the spousal benefit becomes available when the primary beneficiary reaches the FRA and files for his or her benefits, which is indicated in the graph as age 66. As mentioned earlier, this age could fluctuate in accordance with changes in the regulations of the Social Security Administration. Other income sources are shown in area A of the graph. Area B represents the spouse's own Social Security income, which is taken as early as possible (e.g., age 62). Area E represents both the spouse own Social Security income, in addition to spousal Social Security benefits, beginning at the FRA (e.g., age 66). Income from the bridge annuity is shown in area C. As can be readily appreciated, income provided by the annuity “wraps” around existing income sources, so that the client is provided with a consistent level of income during retirement. The primary beneficiary's Social Security income is shown in area D, beginning at age 70.

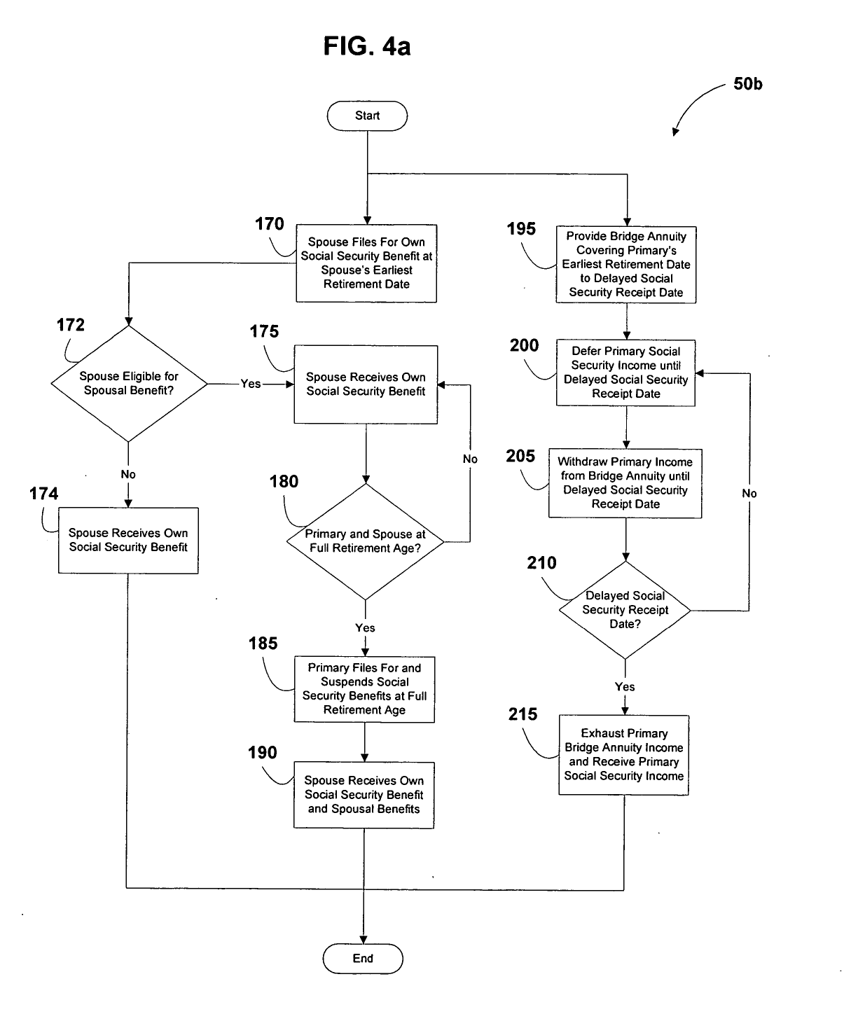

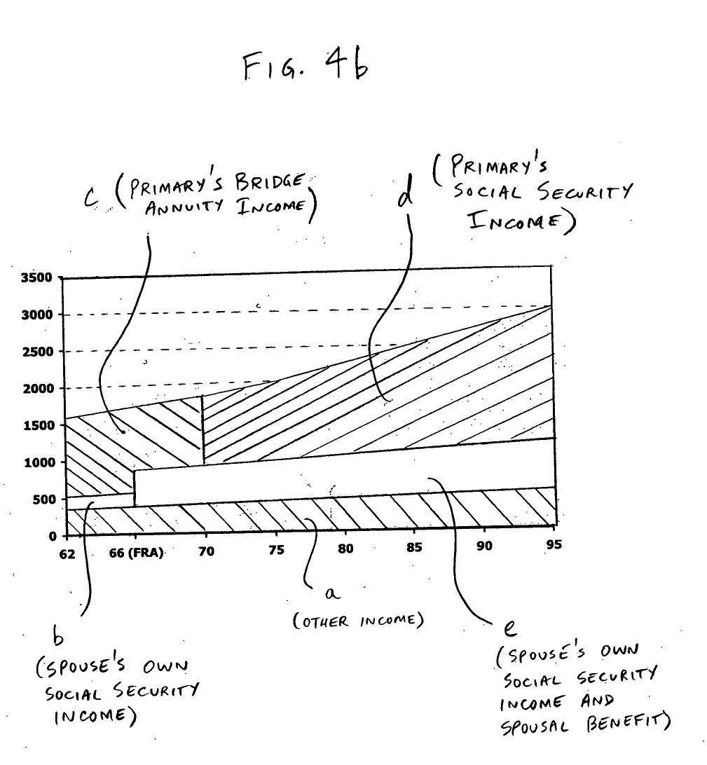

FIG. 4a is a flowchart showing a second income model according to the present invention, indicated generally at 50b. The model 50b projects future income for a married couple wherein the spouse takes his or her own Social Security benefits as soon as eligible, but delays spousal Social Security benefits until both the spouse and the primary recipient reach the full retirement age. Beginning in step 170, the spouse files for his or her own Social Security benefits at the spouse's earliest retirement date (e.g., age 62) when Social Security benefits become available. In step 172, a determination is made as to whether the spouse is eligible to receive a spousal benefit. If a negative determination is made, step 174 occurs, wherein the spouse receives his or her own benefit. If a positive determination is made, step 175 occurs, wherein the spouse continues to receive his or her own benefits, and then step 180 occurs. In step 180, a determination is made as to whether both the primary beneficiary and the spouse are at the FRA (e.g., age 66). If a negative determination is made, step 175 is repeated, and the spouse continues to receive his or her own benefits. If a positive determination is made, step 185 occurs, wherein the primary beneficiary files for and suspends Social Security benefits if the primary beneficiary has not reached a pre-determined delayed Social Security receipt age (e.g., age 70). When the primary beneficiary reaches the pre-determined delayed receipt age, the primary beneficiary files for and receives his or her own Social Security benefits. Then, in step 190, the spouse receives his or her own Social Security benefits, in addition to spousal Social Security benefits.

Concurrent with step 170, step 195 also occurs. In step 195, a bridge annuity is established covering the time period extending between the earliest date of retirement of the primary beneficiary (e.g., age 62) to a pre-determined date for receiving delayed Social Security income benefits. Preferably, the delayed Social Security receipt date is age 70, but other ages could be utilized and modeled. In step 200, the primary beneficiary's Social Security income is deferred until the primary beneficiary reaches the deferred Social Security receipt date. Then, in step 205, income is withdrawn from the bridge annuity until the deferred Social Security receipt date. In step 210, a determination is made as to whether the primary beneficiary has reached the age for receiving deferred Social Security benefits (e.g., age 70). If a negative determination is made, steps 200 and 205 are repeated, so that income is continued to be withdrawn from the bridge annuity and Social Security benefits are deferred. If a positive determination is made in step 210, i.e., the primary beneficiary has reached the age for receiving deferred Social Security benefits (e.g., age 70), then step 215 occurs. In step 215, income from the bridge annuity is exhausted, and the primary beneficiary begins receiving deferred Social Security income.

FIG. 4b is a graph showing projected retirement income using the model shown in FIG. 3a. This graph shows projected income streams for a married couple, wherein a spouse's own Social Security benefits are taken as early as possible and both the spousal Social Security benefit and the primary beneficiary's Social Security income are deferred. Other income sources are shown in area A of the graph. Area B represents the spouse's own Social Security income. At the FRA, spousal Social Security Benefits are also included as income, as shown in area E. Income from the bridge annuity is shown in area C, and occurs from ages 62 to 70. Of course, other durations are possible. The primary beneficiary's Social Security income is shown in area D, beginning at age 70.

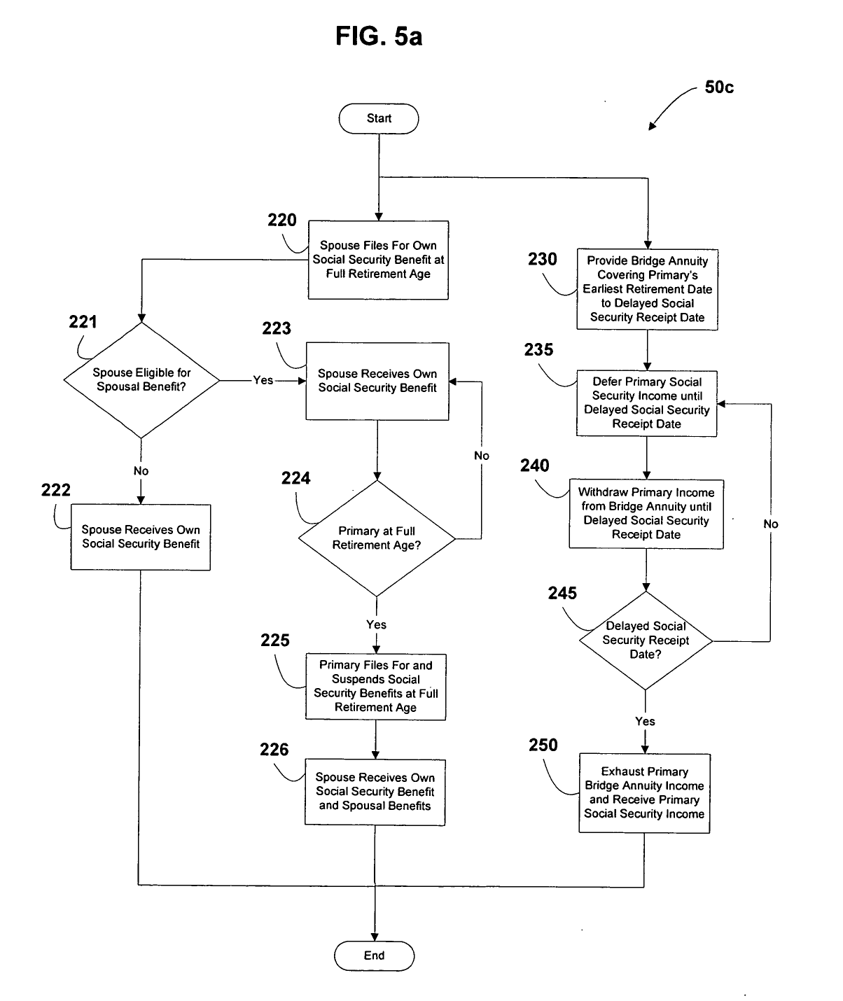

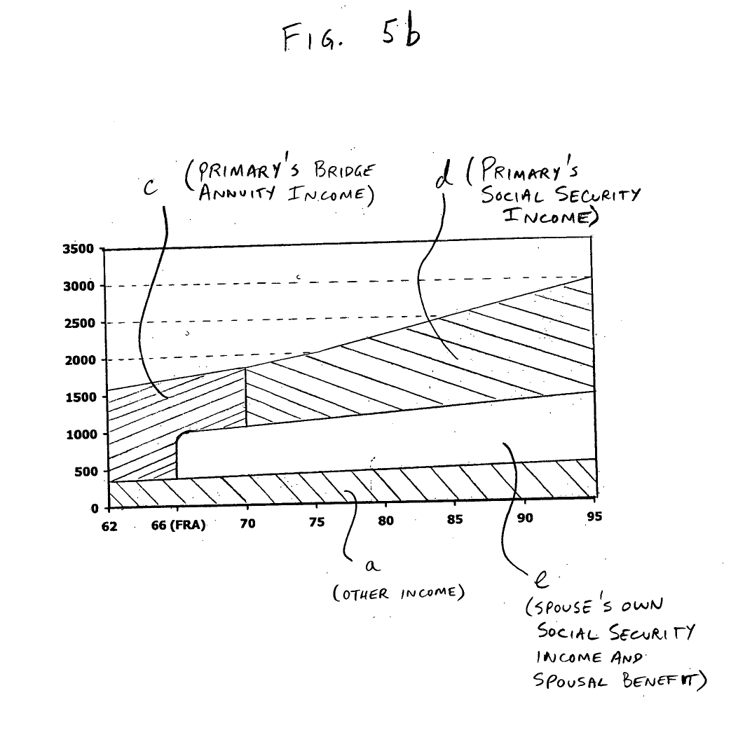

FIG. 5a is a flowchart showing a third income model according to the present invention, indicated generally at 50c. The model 50c projects future income for a married couple wherein the spouse defers his or her own Social Security benefits and spousal Social Security benefits until the spouse reaches the FRA (e.g., age 66). Beginning in step 220, the spouse files for his or her own Social Security benefits when the spouse reaches the FRA (e.g., age 66). In step 221, a determination is made as to whether the spouse is eligible to receive a spousal benefit. If a negative determination is made, step 222 occurs, wherein the spouse receives his or her own Social Security benefit. If a positive determination is made, step 223 occurs, wherein the spouse receives his or her own Social Security benefit. Then, in step 224, a determination is made as to whether the primary beneficiary has reached the FRA. If a negative determination is made, step 223 is repeated, and the spouse continues to receive his or her own Social Security income. If a positive determination is made, step 225 occurs, wherein the primary recipient files for and suspends Social Security benefits at the FRA. Then, in step 226, the spouse receives both his or her own Social Security income and spousal Social Security income.

Concurrent with step 220, step 230 also occurs. In step 230, a bridge annuity is established covering the time period extending between the earliest date of retirement of the primary beneficiary (e.g., age 62) to a pre-determined date for receiving delayed Social Security income benefits. Preferably, the delayed Social Security receipt date is age 70, but other ages could be utilized and modeled. In step 235, the primary beneficiary's Social Security income is deferred until the primary beneficiary reaches the deferred Social Security receipt date. Then, in step 240, income is withdrawn from the bridge annuity until the deferred Social Security receipt date. In step 245, a determination is made as to whether the primary beneficiary has reached the age for receiving deferred Social Security benefits (e.g., age 70). If a negative determination is made, steps 235 and 240 are repeated, so that income is continued to be withdrawn from the bridge annuity and Social Security benefits are deferred. If a positive determination is made in step 245, i.e., the primary beneficiary has reached the age for receiving deferred Social Security benefits (e.g., age 70), then step 250 occurs. In step 250, income from the bridge annuity is exhausted, and the primary beneficiary begins receiving deferred Social Security income.

FIG. 5b is a graph showing projected retirement income using the model shown in FIG. 5a. This graph shows projected income streams for a married couple, wherein a spouse's own Social Security benefits and spousal Social Security benefits are deferred to the FRA (e.g., age 66). Other income sources are shown in area A of the graph. Area E represents the spouse's own Social Security income, taken at age 66. Income from the bridge annuity is shown in area C, and occurs from ages 62 to 70. The income provided by the bridge annuity and shown in area C “wraps around” the income provided in area E, thus providing the client with a consistent level of income in retirement while allowing Social Security benefits to be deferred so as to maximize retirement income. The primary beneficiary's Social Security income is shown in area D of the graph, beginning at age 70.

FIG. 5c is a graph showing projected retirement income using the model shown in FIG. 5a. This graph shows projected income streams for a married couple when the spouse is older than the primary beneficiary, and wherein a spouse's own Social Security benefits and spousal Social Security benefits are deferred to the FRA (e.g., age 66). Importantly, each of the models of the present invention can be applied where spouse are of different ages, and incomes projected taking into account such differences. As shown in FIG. 5c, the spouse does not collect a spousal Social Security benefit until the primary beneficiary has reached the FRA, and collects his or her own Social Security benefit when the spouse has reached the FRA. Other income sources are shown in area A of the graph. Area B sources represents the spouse's own Social Security income, taken when the spouse reaches the FRA (e.g., age 66). Area E represents both the spouses' own Social Security income and spousal Social Security benefits which are taken when the primary beneficiary has reached FRA. Income from the bridge annuity is shown in area C, and occurs from ages 62 to 70. The primary beneficiary's Social Security income is shown in area D of the graph, beginning at age 70.

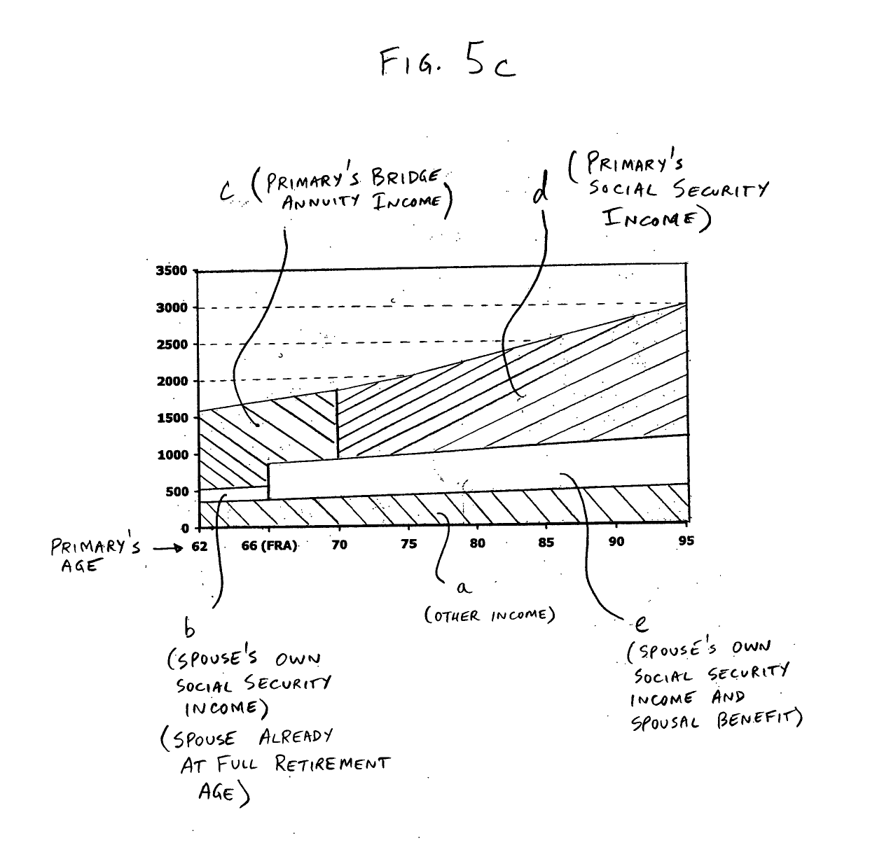

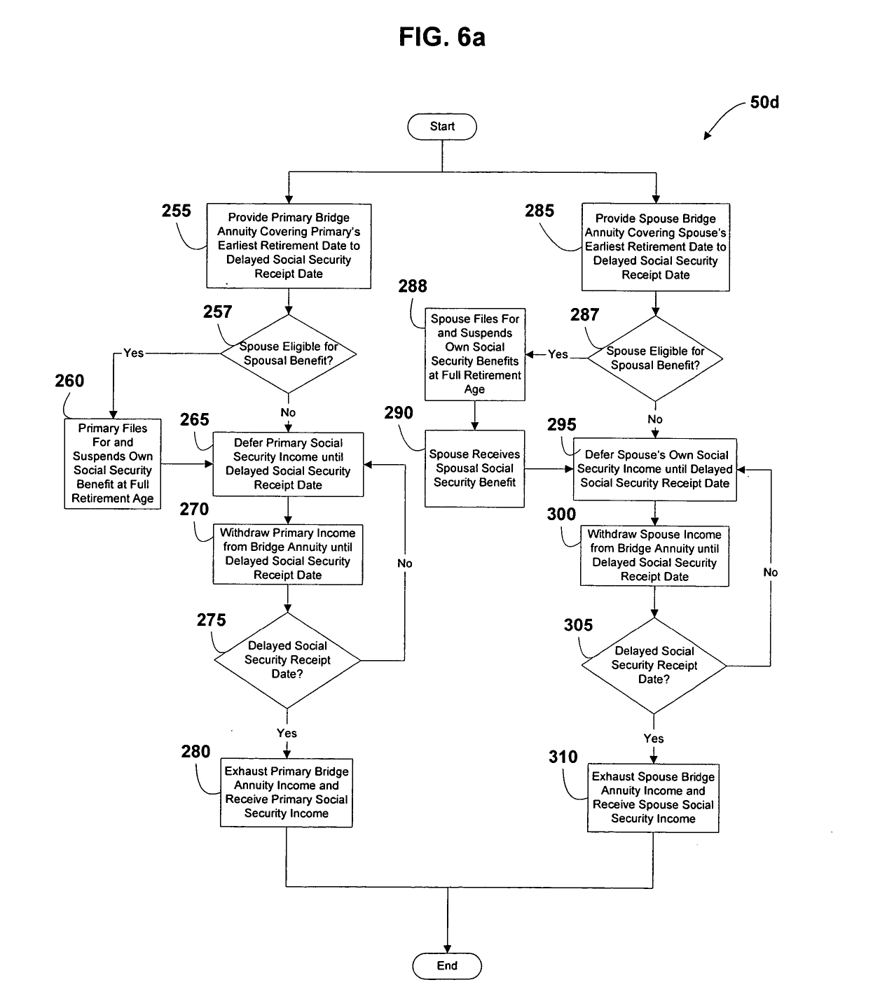

FIG. 6a is a flowchart showing a fourth income model according to the present invention, indicated generally at 50d. The model 50d projects future income for a married couple, wherein both spouses defer Social Security benefits until a pre-determined receipt age (e.g., age 70), and bridge annuities are provided for both spouses. Beginning in step 255, a bridge annuity is established covering the time period extending between the earliest date of retirement of the primary beneficiary to a pre-determined date for receiving delayed Social Security income benefits. Preferably, the delayed Social Security receipt date is age 70, but other ages could be utilized and modeled. In step 257, a determination is made whether the spouse is eligible to collect spousal benefits on the primary beneficiary's record (i.e., the spouse's own Social Security income is less than one half of the primary beneficiary's Social Security income). If a positive determination is made, step 260 occurs, wherein the primary beneficiary files for and suspends his or her own Social Security benefits at the FRA (e.g., age 66). If a negative determination is made, step 265 occurs, wherein the primary beneficiary's Social Security income is deferred until the primary beneficiary reaches the deferred Social Security receipt date. Then, in step 270, income is withdrawn from the bridge annuity until the deferred Social Security receipt date. In step 275, a determination is made as to whether the primary beneficiary has reached the age for receiving deferred Social Security benefits (e.g., age 70). If a negative determination is made, steps 265 and 270 are repeated, so that income is continued to be withdrawn from the bridge annuity and Social Security benefits are deferred. If a positive determination is made in step 275, i.e., the primary beneficiary has reached the age for receiving deferred Social Security benefits (e.g., age 70), then step 280 occurs. In step 280, income from the bridge annuity is exhausted, and the primary beneficiary begins receiving deferred Social Security income.

Concurrent with step 255, step 285 also occurs. In step 285, a bridge annuity is established covering the time period extending between the earliest date of retirement of the spouse to a pre-determined date for receiving delayed Social Security income benefits. Preferably, the delayed Social Security receipt date is age 70, but other ages could be utilized and modeled. In step 287, a determination is made whether the spouse is eligible to collect spousal Social Security benefits on the primary beneficiary's record. If a positive determination is made, then step 288 occurs, wherein the spouse files for and suspends his or her own Social Security benefits at the FRA (e.g., age 66). Then, in step 290, the spouse receives the spousal Social Security benefit off of the primary beneficiary's record. In the event that a negative determination is made in step 287, or after step 290 occurs, then step 295 occurs. In step 295, the spouse's own Social Security income is deferred until the spouse reaches the deferred Social Security receipt date. Then, in step 300, income is withdrawn from the bridge annuity until the deferred Social Security receipt date. In step 305, a determination is made as to whether the spouse has reached the age for receiving deferred Social Security benefits (e.g., age 70). If a negative determination is made, steps 295 and 300 are repeated, so that income is continued to be withdrawn from the bridge annuity and Social Security benefits are deferred. If a positive determination is made in step 305, i.e., the spouse has reached the age for receiving deferred Social Security benefits (e.g., age 70), then step 310 occurs. In step 310, income from the bridge annuity is exhausted, and the spouse begins receiving deferred Social Security income.

FIG. 6b is a graph showing projected retirement income using the model shown in FIG. 6a, wherein the spouse is not eligible to receive spousal benefits under the primary beneficiary's record. This graph shows projected income streams for a married couple, wherein Social Security income for both the spouse and the primary beneficiary is deferred, and two bridge annuities are provided. Other income sources are shown in area A of the graph. Income from the spouse's bridge annuity is shown in area F, and occurs from age 62 to age 70. The spouse's own Social Security income is shown in area G, beginning at age 70. Income from the primary beneficiary's bridge annuity is shown in area C, and the primary beneficiary's Social Security income is shown in area D, beginning at age 70. Importantly, the bridge annuities provided in accordance with model 50d could have varying durations and starting and ending dates, and further, could be staggered to accommodate couples of different ages.

FIG. 6c is a graph showing projected retirement income using the method shown in FIG. 6a, wherein the spouse is eligible for spousal benefits under the primary beneficiary's record. This graph shows projected income streams for a married couple, wherein Social Security income for both the spouse and the primary beneficiary is deferred, and two bridge annuities are provided. Other income sources are shown in area A of the graph. Area H represents spousal Social Security benefits taken off of the primary beneficiary's record, beginning at the FRA. Income from the spouse's bridge annuity is shown in area F, and occurs from age 62 to age 70. Area E represents both the spouse's own Social Security income (deferred until and taken at age 70), as well as spousal Social Security benefits. Income from the primary beneficiary's bridge annuity is shown in area C, and the primary beneficiary's Social Security income is shown in area D, beginning at age 70.

Output from the models can be presented to the client in a form similar to the graphs shown herein, or in any other desired fashion, such as numerically via a series of tables. Outputs from the models can be then compared to alternate income sources so that the client can select the optimum scenario and purchase one or more bridge products in accordance with the optimal scenario.

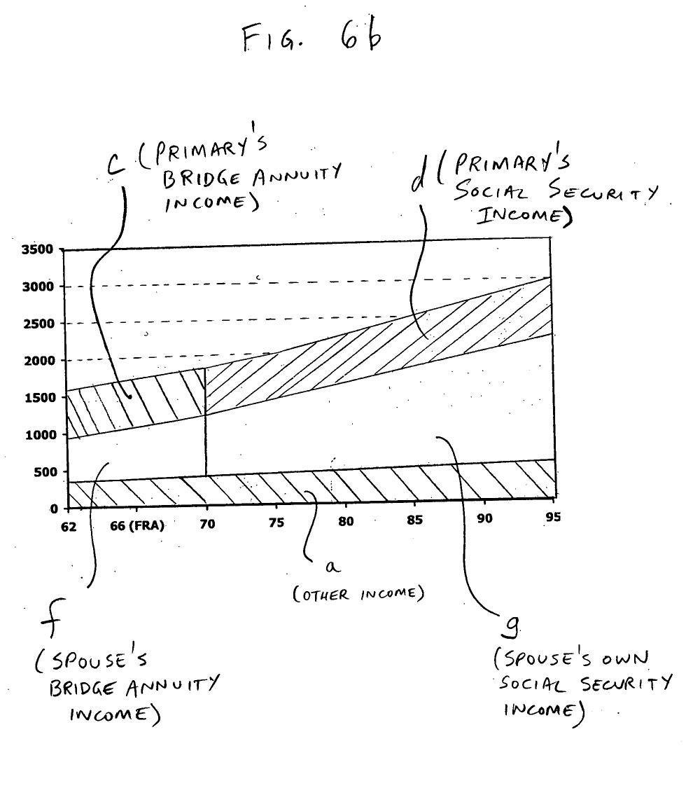

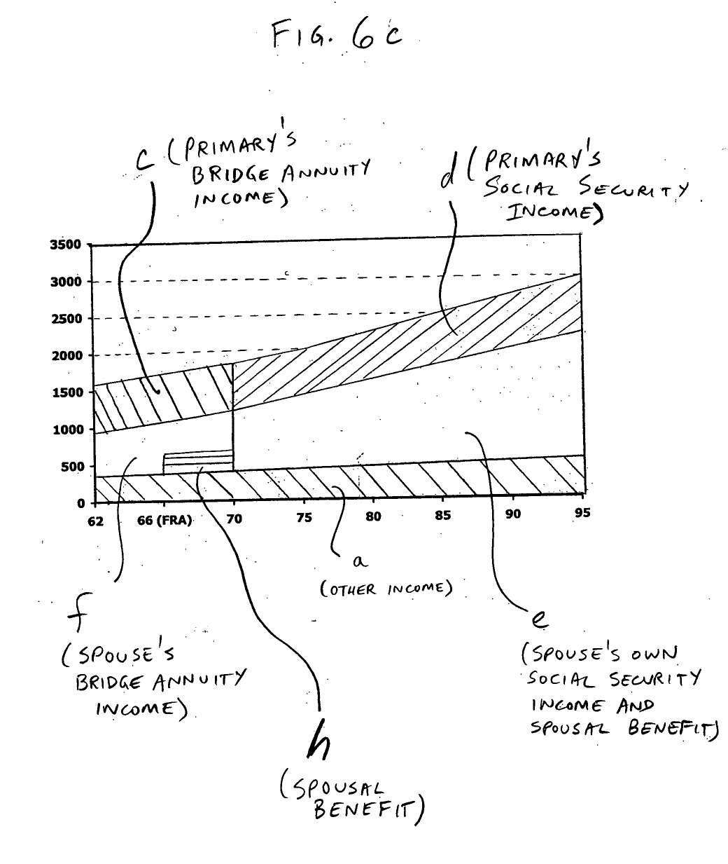

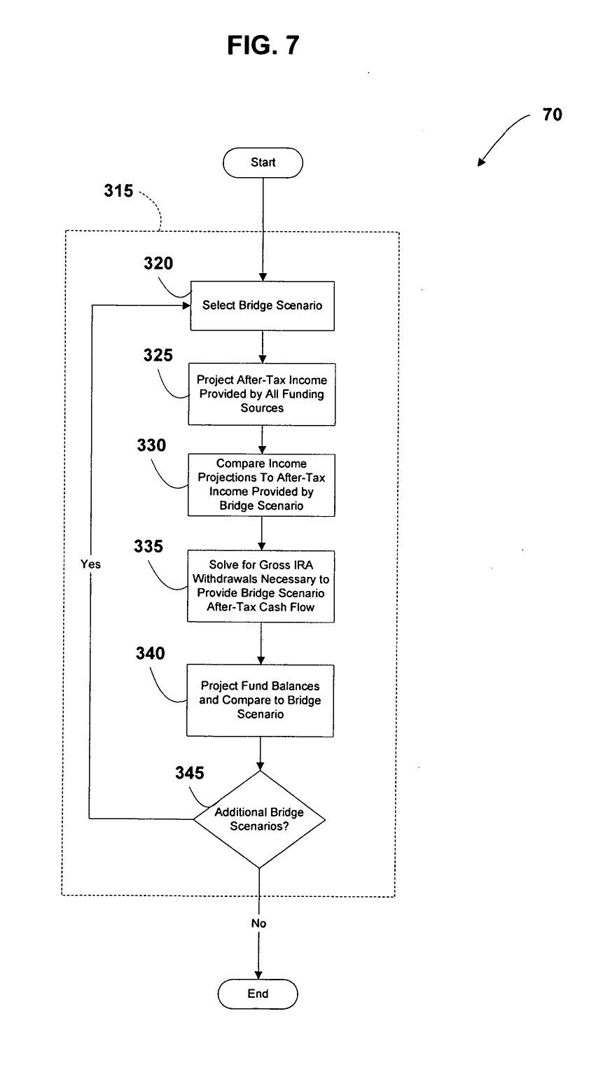

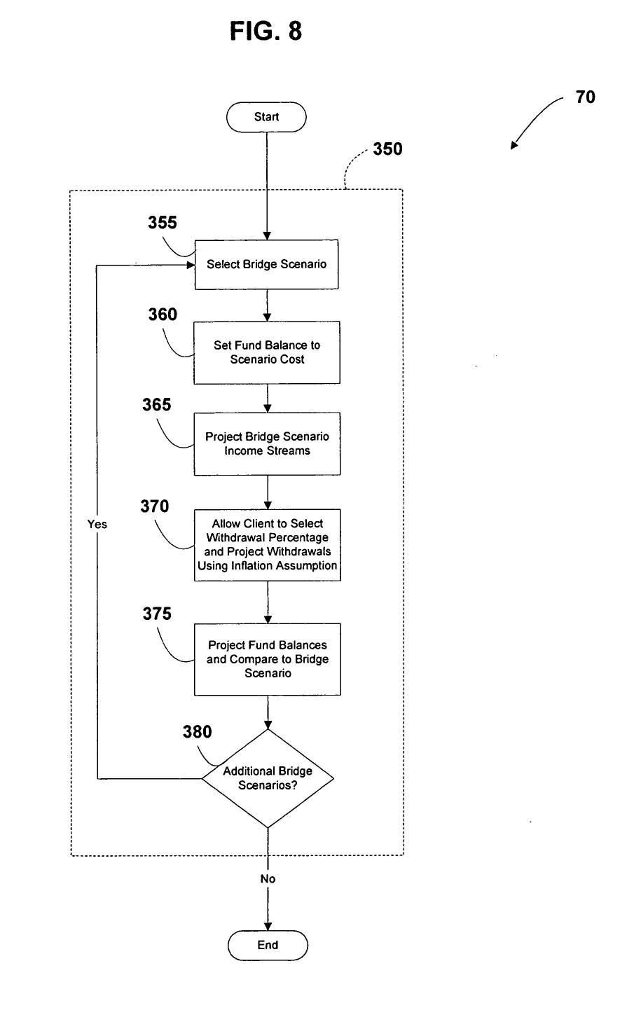

FIGS. 7 and 8 are flowchart showing the alternate funding calculation step 70 of FIG. 1 in greater detail. As mentioned earlier, alternate funding sources, such as the traditional method of taking Social Security benefits prior to full retirement age, and fund addition income (such as IRA withdrawals), can be calculated by the present invention and serve as a basis of comparison with one or more of the scenarios generated by the present invention. As shown in FIG. 7, process 315 allows for calculations of traditional IRA withdrawals, and projects withdrawals required to mach a given scenario.

Beginning in step 320, a bridge scenario is selected. Then, in step 325, after-tax income is projected across all funding sources, including any existing IRA that the client may have. Then, in step 330, the after-tax projections are compared to income provided by the bridge scenario. In step 335, gross IRA withdrawals that are necessary to match the bridge scenario after-tax cash flow are calculated. In step 340, fund balances are projected and compared to the bridge scenario. In step 345, a determination is made as to whether additional bridge scenarios should be modeled. If so, step 320 is repeated so that alternate funding sources can be projected for such bridge scenarios. Alternatively, the initial fund balance for the funding source can be set equal to the annuity cost for comparison purposes. Output of process 315 can be analyzed in a Monte Carlo simulation, or other suitable statistical analysis could be applied.

FIG. 8 shows a process, indicated generally at 350, for calculating fund withdrawals at a fixed percentage for comparison with one or more bridge scenarios. Beginning in step 355, a bridge scenario is selected. Then, in step 360, a fund balance is set to match the cost of the scenario. In step 365, income streams from the bridge scenario are projected. In step 370, the client is allowed to select a withdrawal percentage from the fund balance that the client believes is safe, and withdrawals from the fund balance are projected using an inflation assumption. Then, in step 375, fund balances are projected and compared to the bridge scenario. In step 380, a determination is made as to whether additional bridge scenarios should be modeled. If a positive determination is made, step 355 is repeated, so that alternate funding sources can be projected for such scenarios. Output of process 350 can be analyzed in a Monte Carlo simulation, or other suitable statistical analysis could be applied.

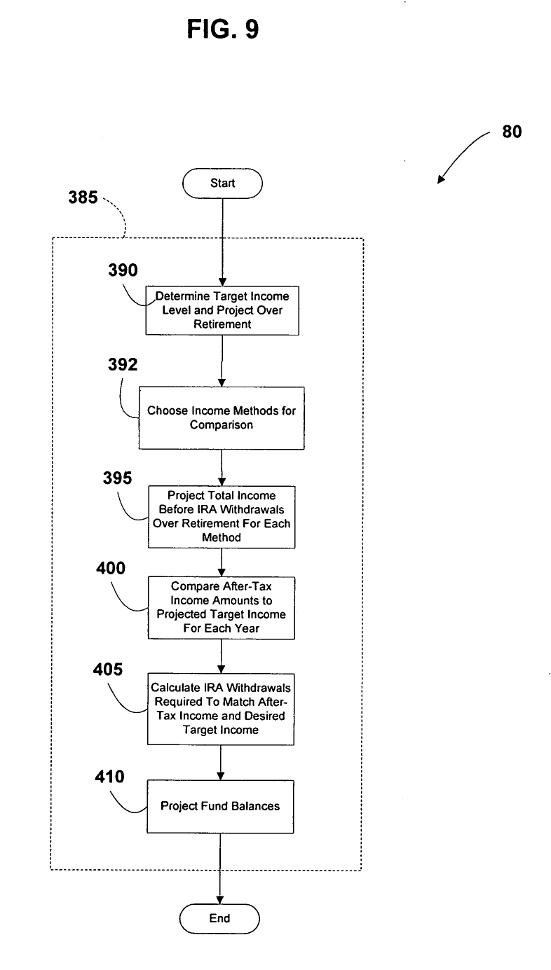

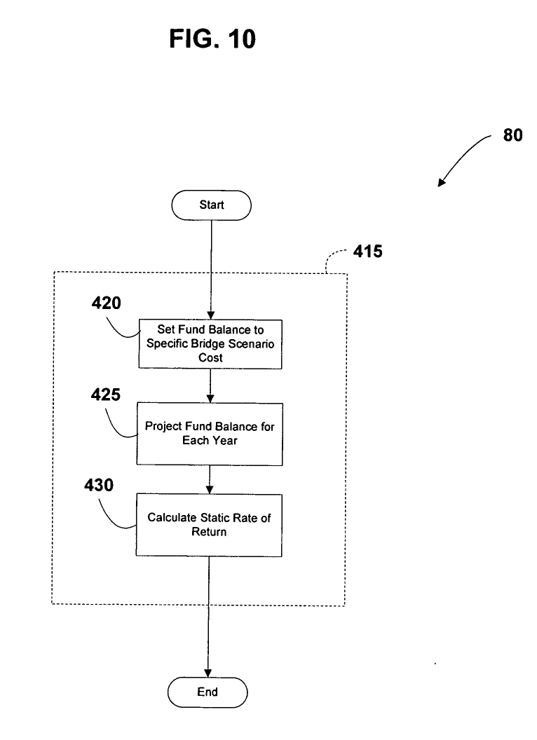

FIGS. 9 and 10 are flowcharts showing the alternate funding comparison step of FIG. 1 in greater detail. FIG. 9 is a flowchart showing process 385, which allows for comparisons of various income methods in the context of a retirement plan and as defined by the ability to meet a targeted income level each year. Target income levels can be accounted for in process 385 and rates of return to be calculated in process 415 shown in FIG. 10. In process 385, beginning in step 390, a target income level is determined (e.g., specified by the client), and income is projected over the client's retirement. In step 392, at least one income method is selected for comparison purposes, including any applicable bridge scenarios and alternative funding methods. Then, in step 395, total income before IRA withdrawals is calculated over the client's retirement for each method. In step 400, after-tax income amounts under each model are compared to the projected target income for each year of the client's retirement. In step 405, IRA withdrawals required to mach after-tax income and desired target income are calculated for each model. In step 410, fund balances are projected for each model,

FIG. 10 is a flowchart showing an additional method, indicated generally as process 415, for comparing funding approaches and determining the relative values of different income models. Any models and alternative funding methods, including those disclosed herein with reference to FIGS. 7-9, can be analyzed by process 415. Beginning in step 420, a fund balance is set for a specific bridge scenario cost. Alternatively, the fund balance can be set equal to all available funds for retirement. Then, in step 425, the fund balance is projected for each year. In step 430, the minimum static rate of return is calculated so that all projected IRA withdrawals under the specified scenario can be made. Optionally, a Monte Carlo simulation can be performed to determine the probability of successfully funding one or more bridge scenarios, or of successfully funding one or more IRA withdrawals.

Importantly, the present invention can be used prior to a client's retirement as a planning tool, wherein various income scenarios are modeled in accordance with the invention. Depending upon the results of modeling, the client can purchase a bridge product ahead of retirement, e.g., at age 40, which product is tailored to future retirement income levels modeled by the present invention. For example, a deferred annuity could be purchased pre-retirement at a discounted rate, and invested over a period of time prior to retirement. Additionally, results of modeling could be used to provide a target future retirement income level. The client could then save and/or invest over a period of time pre-retirement in order to reach the target retirement income level, for example, by purchasing one or more investment products as an accumulation vehicle prior to retirement.

Having thus described the invention in detail, it is to be understood that the foregoing description is not intended to limit the spirit and scope thereof. What is desired to be protected by Letters Patent is set forth in the appended claims.

What is claimed is:

1. A method for maximizing retirement income comprising:
gathering information about a client;
projecting retirement income for the client in a bridge scenario;
calculating an alternate retirement funding approach;
comparing projected retirement income from the bridge scenario to the alternate retirement funding approach; and
allowing the client to select a retirement plan based upon the projected retirement income.

2. The method of claim 1, wherein the step of projecting retirement income for the client comprises projecting retirement income using a bridge product and deferred Social Security income.

3. The method of claim 2, wherein the bridge product comprises a bridge annuity.

4. The method of claim 2, wherein the bridge product comprises a Funding Agreement Note Issuance Program.

5. The method of claim 2, wherein the bridge product comprises a settlement option under a deferred annuity.

6. The method of claim 2, wherein the bridge product comprises a mutual fund.

7. The method of claim 2, wherein the bridge product comprises a certificate of deposit.

8. The method of claim 2, wherein the bridge product comprises a bond.

9. The method of claim 2, wherein the bridge product comprises fixed income.

10. The method of claim 2, wherein the bridge product comprises a retail note.

11. The method of claim 1, wherein the step of projecting retirement income further comprises projecting temporary income during retirement.

12. The method of claim 2, wherein the step of projecting retirement income further comprises:
deferring Social Security income for a client when the client retires and until a delayed receipt age;
providing income from the bridge product when the client retires and until the delayed receipt age; and
exhausting income from the bridge product and allowing the client to receive deferred Social Security income when the client reaches the delayed receipt age.

13. The method of claim 2, wherein the step of projecting retirement income for the client comprises projecting retirement income for a primary beneficiary and a spouse using a bridge product and deferred Social Security income.

14. The method of claim 13, further comprising:
allowing a spouse to receive the spouse's own Social Security income when the spouse retires;
deferring Social Security income for the primary beneficiary from when the primary beneficiary retires until a delayed receipt age;
providing income from the bridge product from when the primary beneficiary retires until the delayed receipt age; and
exhausting income from the bridge product and allowing the primary beneficiary to receive deferred Social Security income from when the primary beneficiary reaches the delayed receipt age.

15. The method of claim 14, further comprising allowing the spouse to receive a spousal Social Security benefit when the primary beneficiary reaches a full retirement age.

16. The method of claim 14, further comprising allowing the spouse to receive a spousal Social Security benefit when the spouse and the primary beneficiary reach a full retirement age.

17. The method of claim 13, further comprising:
allowing the spouse to receive the spouse's own Social Security income when the spouse reaches a full retirement age;
deferring Social Security income for the primary beneficiary from when the primary beneficiary retires until a delayed receipt age;
providing income from the bridge product from when the primary beneficiary retires until the delayed receipt age; and
exhausting income from the bridge product and allowing the primary beneficiary to receive deferred Social Security income from when the primary beneficiary reaches the delayed receipt age.

18. The method of claim 17, further comprising allowing the spouse to receive a spousal Social Security benefit when the primary beneficiary reaches a full retirement age.

19. The method of claim 13, further comprising:
deferring the spouse's own Social Security income from when the spouse retires until a first delayed receipt age;
deferring the primary beneficiary's own Social Security income from when the primary beneficiary retires until a second delayed receipt age;
providing income from a spousal bridge product from when the spouse retires until the first delayed receipt age;
providing income from a primary bridge product from when the primary beneficiary retires until the second delayed receipt age;
exhausting income from the spousal bridge product and allowing the spouse to receive the spouse's own Social Security income at the first delayed receipt age; and
exhausting income from the primary bridge product and allowing the primary beneficiary to receive the primary beneficiary's own Social Security income at the second delayed receipt age.

20. The method of claim 19, further comprising allowing the spouse to receive a spousal Social Security benefit when the primary beneficiary reaches a full retirement age.

21. The method of claim 1, wherein the step of projecting future income comprises:
determining parameters for the bridge scenario;
tallying income sources for each year in bridge scenario;
calculating Social Security income contributions to income for each year in the bridge scenario;
discounting Social Security income contributions from a delayed Social Security receipt age to a retirement date using an inflation assumption;
calculating gross bridge product payments necessary to match the discounted Social Security income; and
wrapping bridge product payments around the discounted Social Security income.

22. The method of claim 21, further comprising re-calculating the bridge scenario using an earlier delayed Social Security receipt date or a later retirement date.

23. The method of claim 22, further comprising discounting pre-tax Social Security income contributions from a delayed Social Security receipt age to a retirement date using an inflation assumption.

24. The method of claim 21, further comprising discounting after-tax Social Security income contributions from a delayed Social Security receipt age to a retirement date using an inflation assumption.

25. The method of claim 1, wherein the step of allowing the client to select a retirement plan further comprises allowing the client to purchase a deferred annuity prior to retirement.

26. The method of claim 2, further comprising determining a target amount for the bridge product prior to retirement and allowing the client to purchase one or more investment vehicles to achieve the target amount.

27. A method for maximizing retirement income for a client comprising:
providing the client with a bridge product providing income from a retirement date until a delayed Social Security receipt age;
allowing the client to defer Social Security income from when the client retires until the delayed Social Security receipt age;
providing income from the bridge product from when the client retires until the delayed receipt age; and
exhausting income from the bridge product and allowing the client to receive deferred Social Security income from when the client reaches the delayed receipt age.

28. The method of claim 27, further comprising providing income from the bridge product prior to the client's retirement.

29. A method for maximizing retirement income for a married client comprising:
providing the client with a bridge product providing income from a primary beneficiary's retirement date until a delayed Social Security receipt age;
allowing the spouse to collect the spouse's own Social Security income from when the spouse retires;
deferring Social Security income for the primary beneficiary from when the primary beneficiary retires until the delayed Social Security receipt age;
providing income from the bridge product from when the primary beneficiary retires until the delayed Social Security receipt age; and
exhausting income from the bridge product and allowing the primary beneficiary to receive deferred Social Security income when the primary beneficiary reaches the delayed Social Security receipt age.

30. The method of claim 29, further comprising allowing the spouse to collect a spousal Social Security benefit when the primary beneficiary reaches a full retirement age.

31. The method of claim 29, further comprising allowing the spouse to collect a spousal Social Security benefit when the spouse and the primary beneficiary reach a full retirement age.

32. The method of claim 29, further comprising providing income from the bridge product prior to the primary beneficiary's retirement.

33. A method for maximizing retirement income for a married client comprising:
providing the client with a bridge product providing income from a primary beneficiary's retirement date until a delayed Social Security receipt age;
allowing the spouse to collect the spouse's own Social Security income from when the spouse reaches a full retirement age;
deferring Social Security income for the primary beneficiary from when the primary beneficiary retires until a delayed receipt age;
providing income from the bridge product from when the primary beneficiary retires until the delayed receipt age; and
exhausting income from the bridge product and allowing the primary beneficiary to receive deferred Social Security income when the primary beneficiary reaches the delayed receipt age.

34. The method of claim 33, further comprising allowing the spouse to receive a spousal Social Security benefit when the primary beneficiary reaches a full retirement age.

35. The method of claim 33, further comprising providing income from the bridge product prior to the primary beneficiary's retirement.

36. A method for maximizing retirement income for a married client comprising:
providing the client with a spousal bridge product and a primary bridge product;
deferring the spouse's own Social Security income from when the spouse retires until a first delayed receipt age;
deferring the primary beneficiary's own Social Security income from when the primary beneficiary retires until a second delayed receipt age;
providing income from the spousal bridge product from when the spouse retires until the first delayed receipt age;
providing income from the primary bridge product from when the primary beneficiary retires until the second delayed receipt age;
exhausting income from the spousal bridge product and allowing the spouse to receive the spouse's own Social Security income at the first delayed receipt age; and
exhausting income from the primary bridge product and allowing the primary beneficiary to receive the primary beneficiary's own Social Security income at the second delayed receipt age.

37. The method of claim 36, further comprising allowing the spouse to receive a spousal Social Security benefit when the primary beneficiary reaches a full retirement age.

38. The method of claim 36, further comprising providing income from the primary bridge product prior to the primary beneficiary's retirement.

39. The method of claim 36, further comprising providing income from the spousal bridge product prior to the spouse's retirement.
